(19) United States
(12) Patent Application Publication
(10) Pub. No.: US 2007/0090252 A1
(43) Pub. Date: Apr. 26, 2007

(54) Safety clothes hook having alterable anchor direction

(75) Inventor: William Chou, Changhua City (TW)

Correspondence Address: BIRCH STEWART KOLASCH & BIRCH, PO BOX 747, FALLS CHURCH, VA, 22040-0747, US

(73) Assignee: SHAMAH INDUSTRIAL CO., LTD.

(21) Appl. No.: 11/229,540

(22) Filed: Sep. 20, 2005

(51) Int. Cl. F16B 45/00

(52) U.S. Cl. 248/304

(57) ABSTRACT

A safety clothes hook having alterable anchor direction includes a base fastened to a wall and multiple pairs of upper brackets and lower brackets fastened to the base. Each pair of the upper and lower brackets are pivotally coupled with a plurality of hooks between them. Each hook has a plurality of insertion portions on the upper side to be inserted by an anchor strut located on a lower side of the hook on the upper side. The upmost hook has a pivot portion on the top to be coupled with a coupling portion of the upper bracket, and a space allowing the hooks to be moved upwards. Thus each hook can be anchored in a selected direction to avoid being hit and moved when in use. When not in use, the hook can be swiveled close to the wall to avoid being extended outside and hitting people.

### FIELD OF THE INVENTION

The present invention relates to a movable hanging hook and particularly to a safety hanging hook which may be anchored in multiple directions and positioned close to a wall without extending outside to avoid hurting people.

### BACKGROUND OF THE INVENTION

There are many types of clothes hooks available on the market. One type has a fixed direction as shown in FIG. 1. The clothes hook 1 thus formed is extended vertically from a wall. When not in use, it is not covered by any thing, thus it is prone to hit people incidentally. As the hook usually is made of metal, the consequence of hitting people is very serious, especially when the head of people is hit. Hence its potential risk is high. It also is not appealing and wastes a lot of space when not in use.

Another type is a swivel clothes hook 2 shown in FIG. 2. It is swivelable freely and cannot be anchored. The hook is easily swiveled to the left side and right side when holding a hat or clothes. When people walk around and touch the hanging articles or clothes, the articles or clothes tend to hit the wall or other objects, or even drop to the floor and result in smearing.

### SUMMARY OF THE INVENTION

In view of the aforesaid disadvantages, the primary object of the present invention is to provide an improved safety clothes hook with alterable anchor direction so that it can be positioned in a desired direction when in use and swiveled close to a wall for anchoring when not in use. The safety clothes hook according to the invention includes a base fastened to a wall, and a plurality of upper brackets and lower brackets fastened to the base in a up and down manner. A plurality of hooks may be hinged between the upper bracket and the lower bracket. Each hook has a plurality of insertion portions to be coupled with an anchor strut located on a lower side of the upper hook. The anchor strut on the bottom of the lowest hook can be inserted into an insertion portion formed on the lower bracket. The upmost hook has a pivot portion on the top to be coupled with a coupling portion formed on the upper bracket. The pivot portion has a space allowing the hook to be moved upwards. Hence the hook can be moved and anchored in various directions when in use to prevent the hanging articles or clothes from being moved to hit the wall or other objects, and dropping to the floor. The hook also can be moved close to the wall and anchored when not in use to avoid the protrusive hook from hitting people.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional fixed clothes hook.

FIG. 2 is a perspective view of a conventional swivel clothes hook.

FIG. 3 is an exploded view of a first embodiment of the present invention.

FIG. 4A is a sectional view of the first embodiment of the present invention.

FIG. 4B is a schematic view of the first embodiment shown in

FIG. 4A in an operating condition.

FIG. 5A is a plain view of the first embodiment of the present invention.

FIG. 5B is a schematic view of the first embodiment shown in

FIG. 5A in an operating condition.

FIG. 6 is a sectional view of a second embodiment of the present invention.

FIG. 7 is a sectional view of a third embodiment of the present invention.

FIG. 8 is a perspective view of a fourth embodiment of the present invention.

FIG. 9 is a sectional view of a fifth embodiment of the present invention.

FIG. 10 is an exploded view of a sixth embodiment of the present invention.

FIG. 11A is a plain view of the sixth embodiment of the present invention.

FIG. 11B is a cross section taken on line 11B-11B in FIG. 11A.

FIG. 12 is an exploded view of a seventh embodiment of the present invention.

FIG. 13 is a sectional view of an eighth embodiment of the present invention.

FIG. 14 is a sectional view of a ninth embodiment of the present invention.

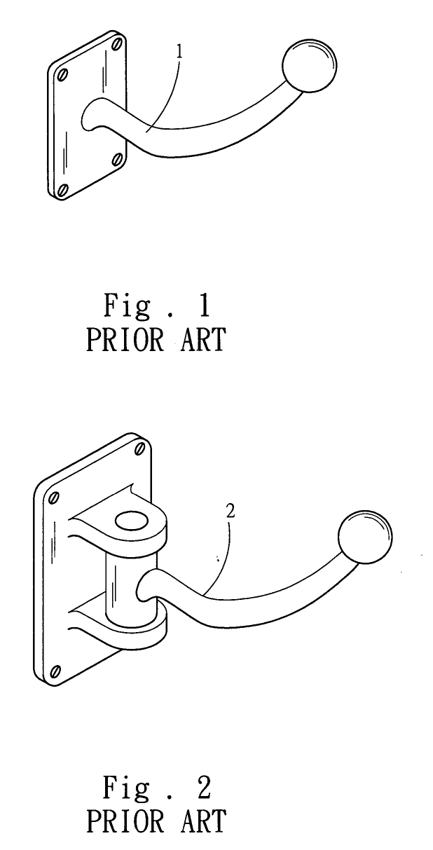

### DETAILED DESCRIPTION OF THE PREFERRED EMBODIMENTS

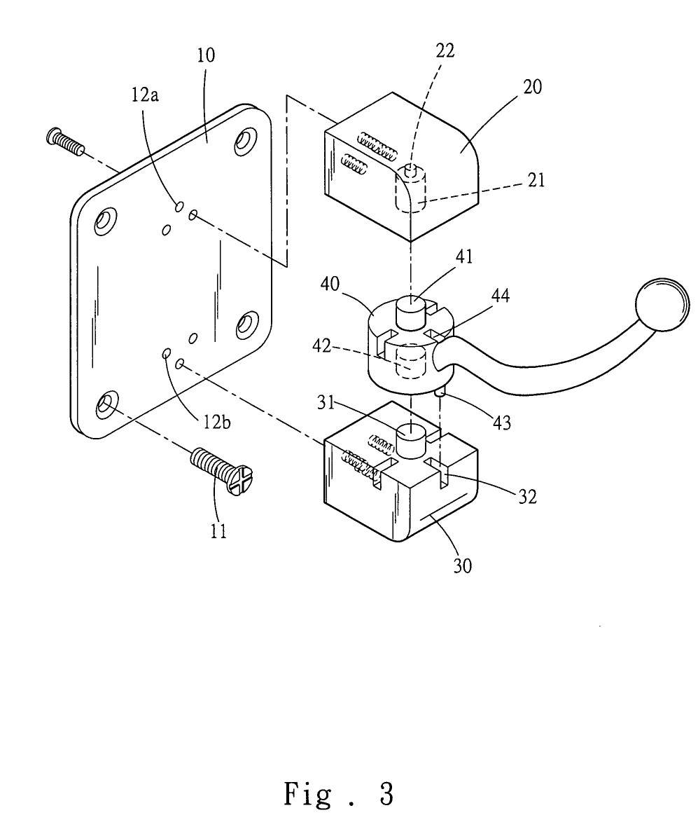

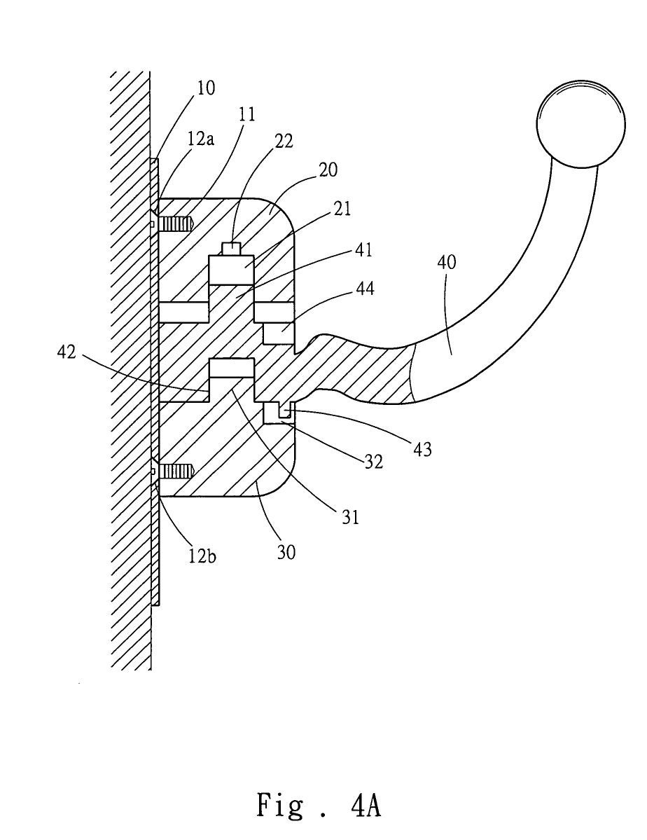

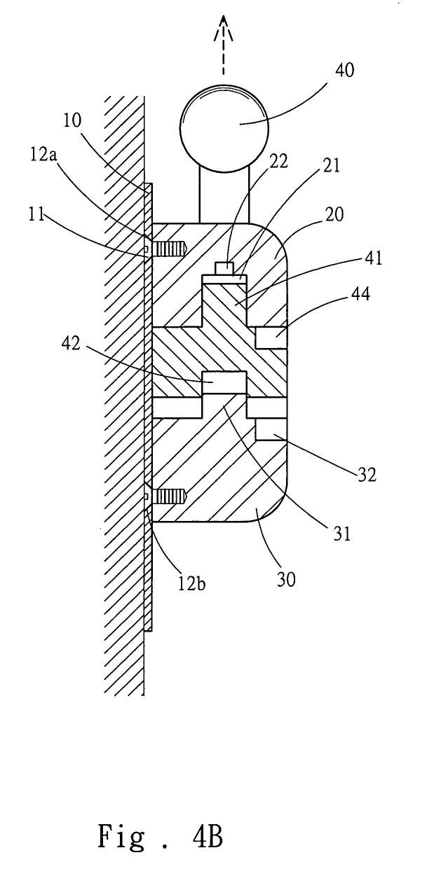

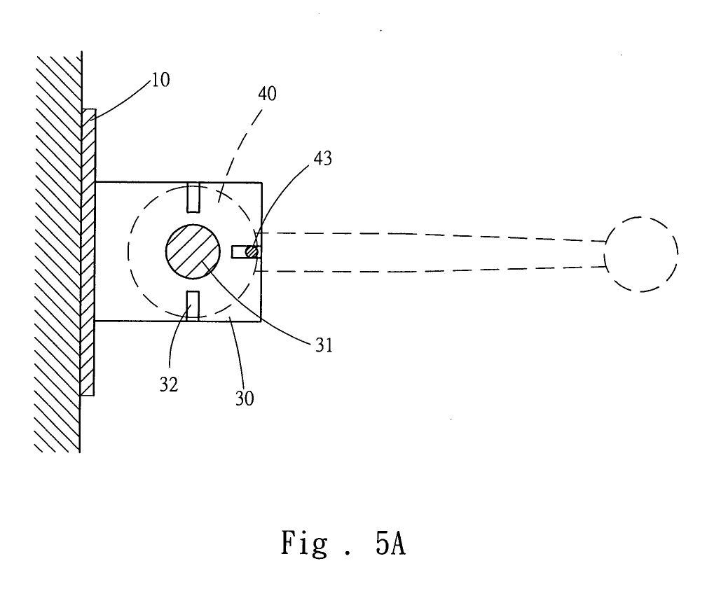

Please refer to FIGS. 3 and 4A for a first embodiment of the safety clothes hook having alterable anchor direction of the invention. It includes a board type base 10 to be fastened to a wall on four corners through fastening elements 11 (such as screws). The base 10 has first apertures 12a on an upper side and second apertures 12b on a lower side. The first apertures 12a are engaged with screws to fasten an upper bracket 20 to the base 10 (the upper bracket 20 may also be integrally formed with the base 10). The second apertures 12b are engaged with screws to fasten a lower bracket 30 to the base 10 (the lower bracket 30 may also be integrally formed with the base 10. But the upper and lower brackets 20 and 30 are not integrally formed with the base 10 at the same time).The upper bracket 20 has an indented first coupling portion 21 which has a cavity 22 on the top surface thereof. The lower bracket 30 has a plurality of indented first insertion troughs 32 on the top surface thereof and a protrusive first pivot portion 31 in the center.

There is a hook 40 located between the upper bracket 20 and the lower bracket 30 to be pivotally coupled with the upper bracket 20 and the lower bracket 30, and is swivelable. The hook 40 has a protrusive second pivot portion 41 on the top and an indented second coupling portion 42 on the bottom, and an anchor strut 43 on the bottom surface thereof. The hook 40 further has a plurality of indented second insertion portions 44 on the top surface formed in different directions.

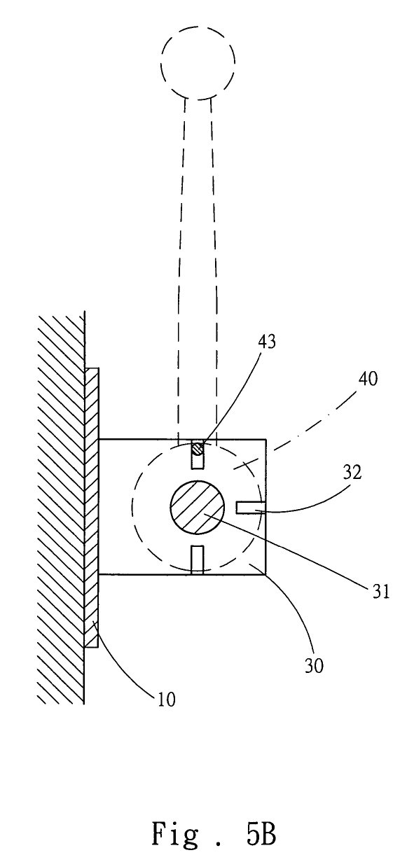

By means of the construction set forth above, the second coupling portion 42 on the bottom of the hook 40 can be coupled with the first pivot portion 31 of the lower bracket 30. The anchor strut 43 can be selectively inserted into one of the first insertion portions 32 to anchor the hook 40 in a selected direction. The second pivot portion 41 on the upper side of the hook 40 can be coupled with the first coupling portion 21 of the upper bracket 20. Once the second pivot portion 41 of the hook 40 is coupled with the first coupling portion 21, the first coupling portion 21 still has space allowing the hook 40 to be moved upwards (referring to FIG. 4B) so that the anchor strut 43 may be disengaged from the first insertion portion 32 of the lower bracket 30 and swiveled. Thereby the anchor strut 43 may be inserted into another first insertion portion 32 of the lower bracket 30. Thus when in use the hook 40 may be swiveled outwards and anchored as desired. And when not in use, the hook 40 may be swiveled close to the wall and anchored as shown in FIGS. 5A and 5B.

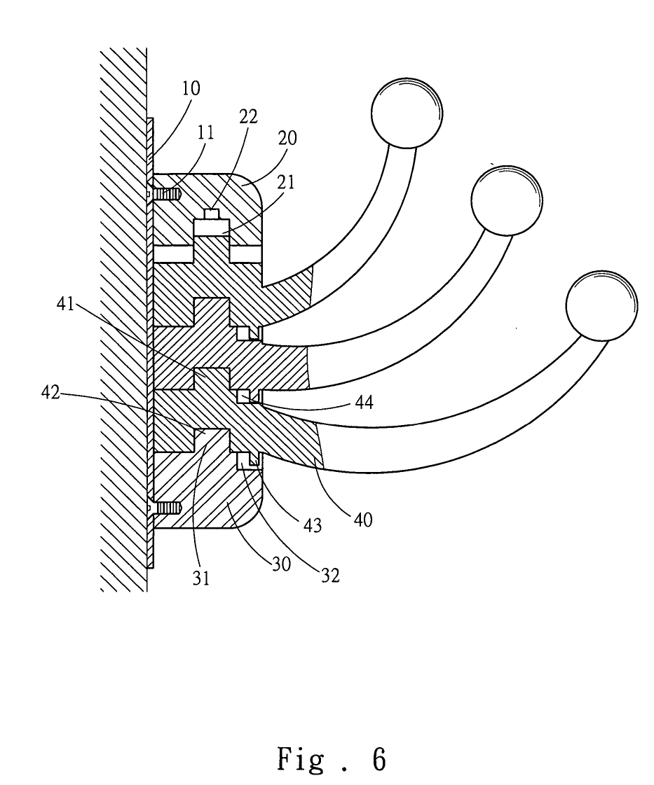

Refer to FIG. 6 for a second embodiment of the invention. A plurality of the hooks 40 may be coupled in series in an up and down manner. The anchor strut 43 on the upper hook 40 can be inserted into the second insertion portions 44 on the top surface of the lower hook 40.

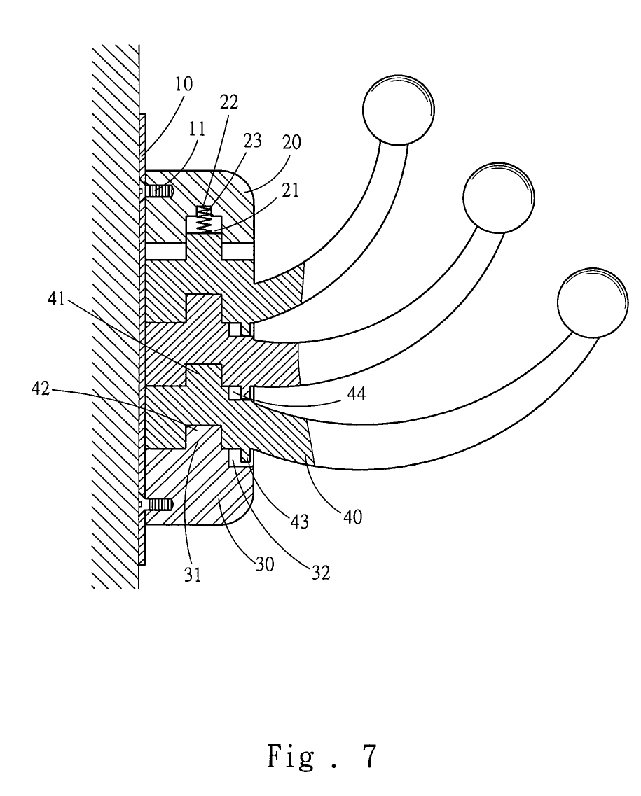

Refer to FIG. 7 for a third embodiment of the invention. The cavity 22 on the upper bracket 20 houses an elastic element 23 (such as a spring). The elastic element 23 has a lower end pressing the protrusive second pivot portion 41 of the upmost hook 40 to prevent the hook 40 from bouncing up and down when installed on bumpy locations such as vehicles.

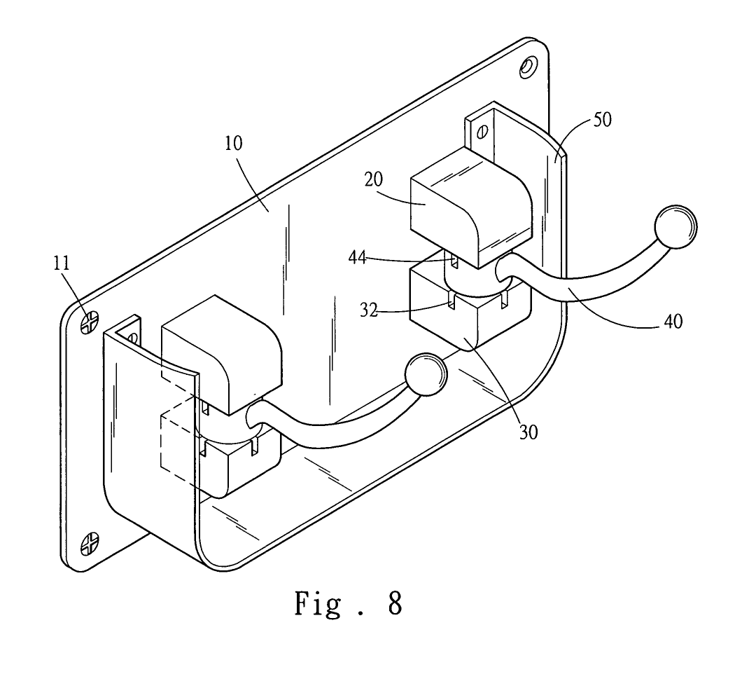

Refer to FIG. 8 for a fourth embodiment of the invention. A plurality of upper brackets 20, lower brackets 30 and hooks 40 are fastened to the base 10. The left side, right side and lower side of the base 10 are surrounded by an arched guarding plate 50 to confine the upper bracket 20 and lower bracket 30 inside to avoid hitting and hurting people.

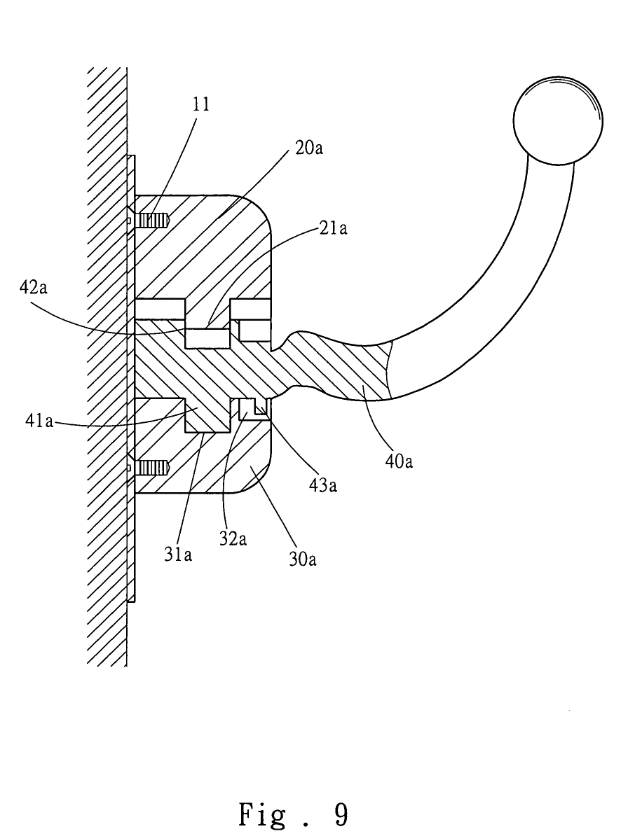

Refer to FIG. 9 for a fifth embodiment of the invention. It includes a hook 40a which has an indented second coupling portion 42a on an upper side and a protrusive second pivot portion 41a on a lower side. A mating lower bracket 30a is located beneath the hook with an indented first coupling portion 31a on the top to be coupled with the second pivot portion 41a. The upper bracket 20a has a protrusive first pivot portion 21a on the bottom to be coupled with the second coupling portion 42a of the hook 40a. The hook 40a has an anchor strut 43a on a lower side to be inserted into the first insertion portion 32a formed on the lower bracket 30a. Use method is the same as the embodiment depicted in FIGS. 3 and 4.

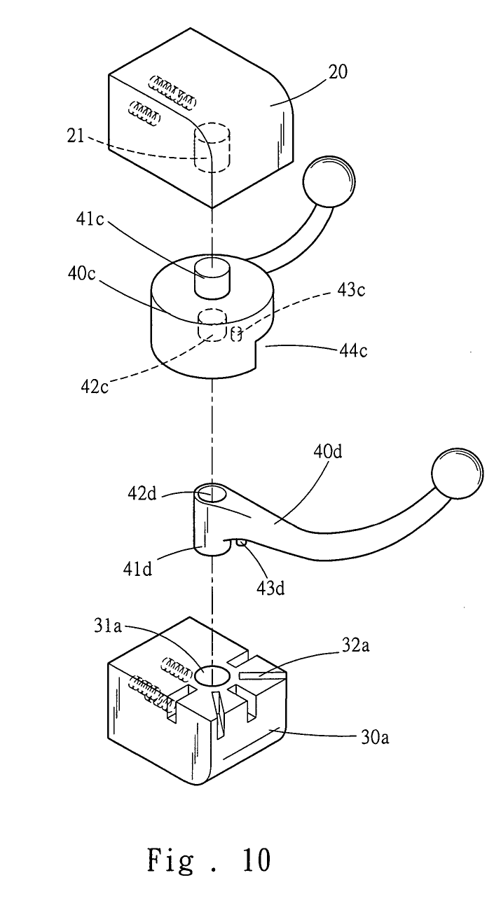

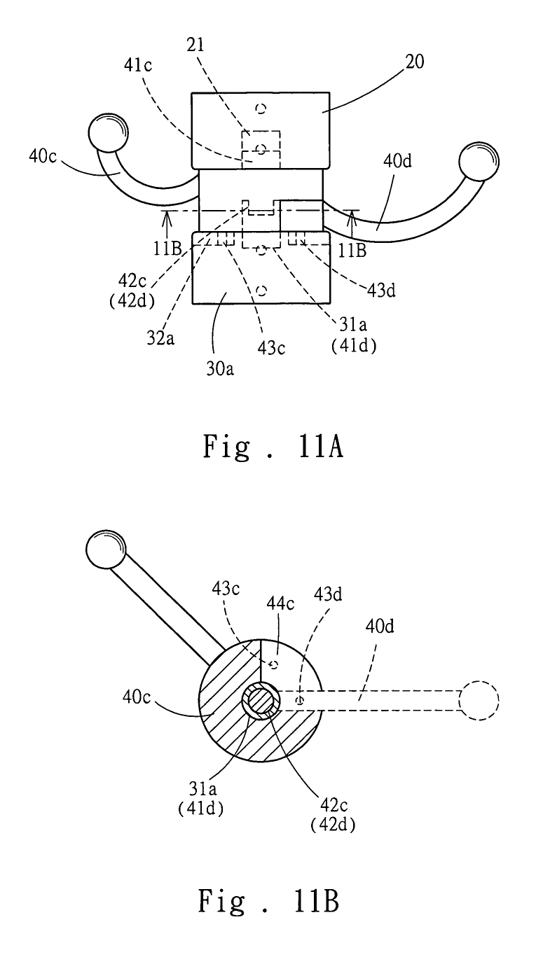

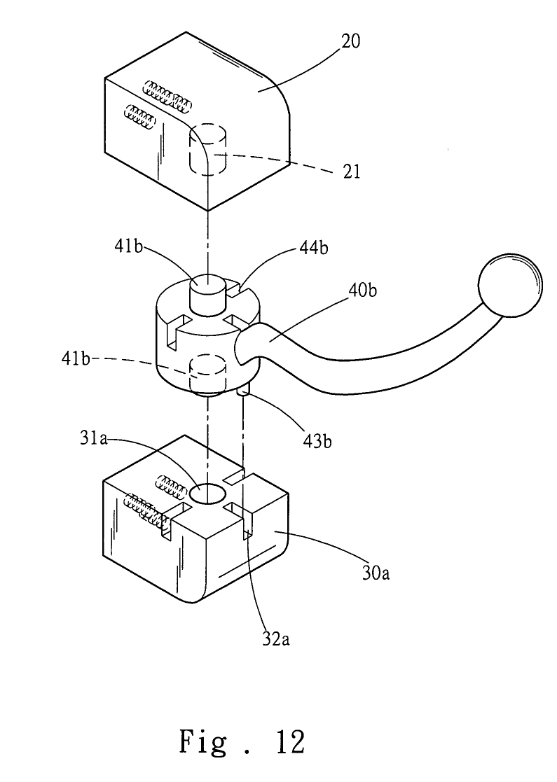

Refer to FIGS. 10, 11A and 11B for a sixth embodiment of the invention that has double hooks. It includes an upper bracket 20 and a lower bracket 30a. The upper bracket 20 has an indented first coupling portion 21. The lower bracket 30a has an indented first coupling portion 31a on the top surface. The first coupling portion 31a is surrounded by a plurality of first insertion portions 32a. An upper hook 40c and a lower hook 40d are stacked in an up and down manner, and pivotally coupled together. The upper hook 40c has a protrusive second pivot portion 41c on the top and a protrusive third pivot portion 42c on the lower side, and a cut away notch 44c on the periphery, and an anchor strut 43c on the bottom thereof. The upper hook 40c and the lower hook 40d have the bottom surfaces at the same horizontal level. For assembly, the second pivot portion 41c of the upper hook 40c is coupled with the first coupling portion 21 of the upper bracket 20. The lower hook 40d has a fourth pivot portion 41d coupled with the first coupling portion 31a of the lower racket 30a. Referring to FIGS. 1A and 1B, the upper hook 40c or lower hook 40d may be swiveled, and the anchor strut 43c on the bottom of the upper hook 40c (or the anchor strut 43d on the bottom of the lower hook 40d ) may be inserted into the first insertion portion 32a of different directions to achieve anchoring effect. Therefore the hooks 40c and 40d can be swiveled and anchored to hang clothes and articles. When not in use, the hooks 40c and 40d may be swiveled close to the wall for anchoring to avoid hitting people.

Refer to FIG. 12 for a seventh embodiment of the invention. It adopts the upper bracket 20 and lower bracket 30a shown in FIGS. 10 and 11A, but with only one hook 40b. The hook 40b has respectively a protrusive second pivot portion 41b on the upper side and lower side to be coupled with a third coupling portion 31a on the lower bracket 30a and a first coupling portion 21 on the upper side 20. The hook 40b has an anchor strut 43b on the bottom corresponding to any one of the first insertion portions 32a of the lower bracket 30a. The hook 40b further has a plurality of second insertion portions 44b formed on the periphery of the top to be coupled with another anchor strut 43 of another upper hook 40 (not shown in the drawing) to form a product equipped with multiple hooks 40b.

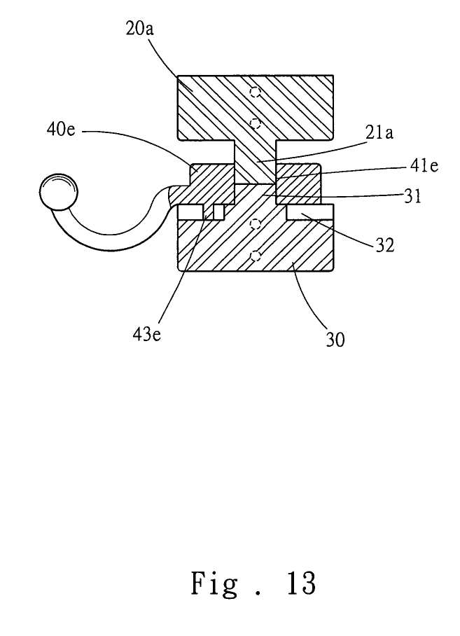

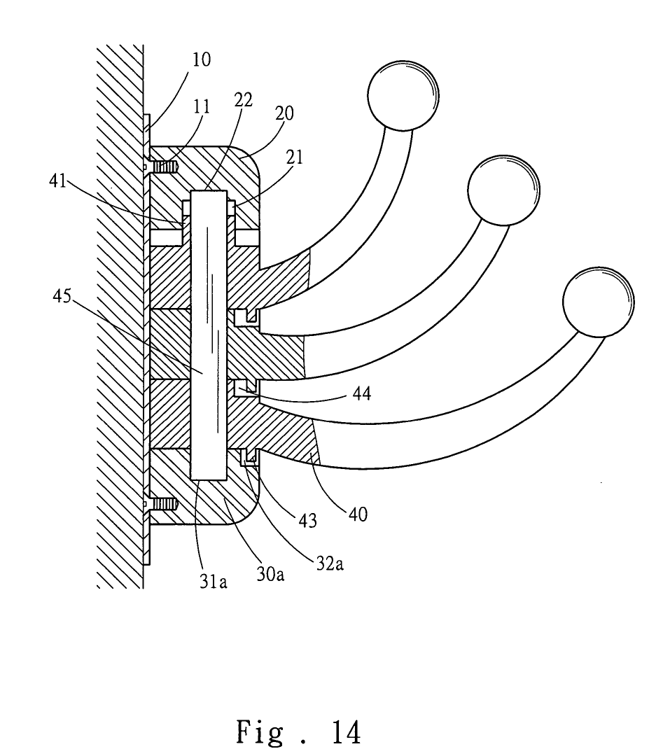

Refer to FIG. 13 for an eighth embodiment of the invention. It includes a hook 40e which has an upper side and a lower side that are horizontal, and an axle hole 41e in the center. The axle hole 41e can be coupled with a first pivot portion 21a on the bottom of the upper bracket 20a. The axle hole 41e has a lower end to be pivotally coupled with a third pivot portion 31 on the top of the lower bracket 30. The hook 40e has an anchor strut 43e on the bottom. The lower bracket 30 has a plurality of first insertion portions 32 on the top surface to be coupled with the anchor strut 43e for anchoring. Refer to FIG. 14 for a ninth embodiment of the invention. It mainly includes an upper bracket 20 and a lower bracket 30a. The lower bracket 30a has an indented third coupling portion 31a on the top surface, and a plurality of first insertion portions 32a around the third coupling portion 31a. A central post 45 is provided with the bottom coupled in the third coupling portion 31a of the lower bracket 30a. A plurality of hooks 40 are coupled on the central post 45 in a series manner. Each hook 40 has an anchor strut 43 on the bottom and a plurality of second insertion portions 44 on the top to be inserted by the anchor strut 43 on the upper hook 40. The hook 40 at the bottom has an anchor strut 43 to be coupled with one of the first insertion portions 32a of the lower bracket 30a. The upmost hook 40 has a protrusive second pivot portion 41 to be coupled with the first coupling portion 21 on the bottom of the upper bracket 20. The cavity 22 on the top of the first coupling portion 21 can be coupled with the top end of the central post 45. The top end of the upmost hook 40 and the bottom side of the upper bracket 20 are spaced by an interval to allow the hooks 40 to be moved upwards.

In summary, the hooks 40, 40a, 40b, 40c, 40d and 40e of the invention can be anchored in a selected direction when in use to avoid being hit and moved by people, and prevent the clothes and articles hung on the hooks from being moved to hit the wall or dropping to the floor and smearing. When not in use, the hooks may be swiveled close to the wall for anchoring to avoid extending outside and hitting people.

What is claimed is:

1. A safety clothes hook having alterable anchor direction, comprising:
an upper bracket which has one side fastenable to a wall and a first coupling portion on the bottom thereof;
a lower bracket located beneath the upper bracket having one side fastenable to the wall and a first pivot portion on the top thereof, and a plurality of indented first insertion portions around the first pivot portion; and
at least one hook located between the upper bracket and the lower bracket, the upmost hook having the top end mating the first coupling portion of the upper bracket, the hook at the bottom being pivotally coupled with the first pivot portion of the lower bracket, the first coupling portion of the upper bracket having a space allowing the hook to be moved upwards, each hook having an anchor strut on the bottom thereof to be inserted into one of the first insertion portions located beneath on another hook, a plurality of second insertion portions being formed on the top surface of each hook to be engaged with the anchor strut on the upper hook, the anchor strut on the hook at the bottom being insertable into one of the first insertion portions of the lower bracket.

2. The safety clothes hook of claim 1, wherein the hook has a protrusive second pivot portion on the top to be coupled with the indented first coupling portion on the bottom of the upper bracket, and an indented second coupling portion on the bottom to be coupled with the protrusive first pivot portion of the lower bracket.

3. The safety clothes hook of claim 2, wherein the first coupling portion of the upper bracket has a cavity on the bottom surface thereof to hold an elastic element which and the elastic element has a lower end pressing the second pivot portion of the hook.

4. The safety clothes hook of claim 2, wherein the upper bracket and the lower bracket are fastened to a plate type base, the base having at least a pair of apertures on an upper side and a lower side to be engaged with screws to fasten the upper bracket and the lower bracket to the base, the base having four corners each being engaged with a fastening element to fasten the base to the wall.

5. The safety clothes hook of claim 4, wherein the base is fastened to an arched guarding plate which surrounds a left side, a right side and a lower side of the base.

6. A safety clothes hook having alterable anchor direction, comprising:
an upper bracket which has one side fastenable to a wall and a protrusive first pivot portion on the bottom thereof;
a lower bracket located beneath the upper bracket having one side fastenable to the wall and an indented first coupling portion on the top thereof, and a plurality of indented first insertion portions on the top surface; and
at least one hook which has an indented second coupling portion on the top, the second coupling portion of the upmost hook being coupled with the first pivot portion of the upper bracket and having a space allowing the hook to be moved upwards, each hook having a second pivot portion extended downwards from the bottom thereof, the second pivot portion of the hook at the bottom being coupled with the first coupling portion of the lower bracket, the hook also having an anchor strut on the bottom thereof to be inserted into one of the first insertion portions located beneath on another hook, a plurality of second insertion portions being formed on the top surface of the hook to be engaged with the anchor strut on the upper hook, the anchor strut on the hook at the bottom being insertable into one of the first insertion portions of the lower bracket.

7. The safety clothes hook of claim 6, wherein the upper bracket and the lower bracket are fastened to a plate type base, the base having at least a pair of apertures on an upper side and a lower side to be engaged with screws to fasten the upper bracket and the lower bracket to the base, the base having four corners each being engaged with a fastening element to fasten the base to the wall.

8. The safety clothes hook of claim 7, wherein the base is fastened to an arched guarding plate which surrounds a left side, a right side and a lower side of the base.

9. A safety clothes hook having alterable anchor direction, comprising:
an upper bracket which has one side fastenable to a wall and an indented first coupling portion on the bottom thereof;
a lower bracket located beneath the upper bracket having one side fastenable to the wall and an indented third coupling portion on the top thereof, and a plurality of indented first insertion portions around the third coupling portion;
an upper hook and a low hook pivotally coupled with each other in an up and down manner, the upper hook having a protrusive second pivot portion engageable with the first coupling portion of the upper bracket, a cut away notch on the periphery, and an anchor strut located on the bottom thereof; and
the lower hook being swivelabe in the notch and having a protrusive third pivot portion on the bottom thereof, the third pivot portion being coupled with the third coupling portion of the lower bracket, the lower hook also having an anchor strut on the bottom insertable into one of the first insertion portions of the lower bracket.
